(19) United States
(12) Patent Application Publication
(10) Pub. No.: US 2025/0126399 A1
(43) Pub. Date: Apr. 17, 2025

(54) INTER-DEVICE NOISE ALERTS FOR ELECTRONIC DEVICES

(71) Applicant: Apple Inc., Cupertino, CA (US)

(72) Inventors: David M. FISCHER, San Francisco, CA (US); Lucas O. WINSTROM, Portola Valley, CA (US); Michael GILES, San Jose, CA (US); Sriram HARIHARAN, San Jose, CA (US); Michael TANNE, Alamo, CA (US)

(21) Appl. No.: 18/807,877

(22) Filed: Aug. 16, 2024

Related U.S. Application Data
(60) Provisional application No. 63/544,613, filed on Oct. 17, 2023.

(51) Int. Cl. H04R 1/10; G10K 11/16

(52) U.S. Cl. CPC H04R 1/1083; G10K 11/16; H04R 1/1016

(57) ABSTRACT

Inter-device noise alerts may allow an electronic device, such as a smart phone or a smart watch, of one user to alert one or more electronic devices, such as smart phones, of one or more other users, that the noise level in a noise environment in which the electronic devices and the users are located may be unsafe for prolonged exposure. This can provide beneficial power savings by facilitating alerts from multiple devices without all of the multiple devices continuously monitoring the noise level. This also can be helpful for notifying the other users when, for example, the electronic devices of the other users are in a pocket, a bag, or another container and unable to detect the full noise level directly. The electronic devices of the other users can then provide alerts to the other users to don hearing protection or to leave the noise environment.

### CROSS REFERENCE TO RELATED APPLICATIONS

This application claims the benefit of priority to U.S. Provisional Patent Application No. 63/544,613, entitled, “Inter-Device Noise Alerts For Electronic Devices”, filed on Oct. 17, 2023, the disclosure of which is hereby incorporated herein in its entirety.

### TECHNICAL FIELD

The present description relates generally to electronic devices including, for example, to inter-device noise alerts for electronic devices.

### BACKGROUND

Electronic devices, including audio devices such as headphones and earbuds, can include speakers for outputting sound to a user's ears, and microphones for capturing the sound from an environment of the electronic device.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example system architecture including various electronic devices that may implement the subject system in accordance with one or more implementations.

FIG. 2 illustrates first and second electronic devices in a noise environment in accordance with implementations of the subject technology.

FIG. 3 illustrates an electronic device receiving a noise notification and sound from the noise environment in accordance with implementations of the subject technology.

FIG. 4 illustrates an electronic device receiving a noise notification from another electronic device while being located in a pocket of a user in accordance with one or more implementations of the subject technology.

FIG. 5 illustrates multiple electronic devices associated with the same user account obtaining audio samples from a noise environment in accordance with one or more implementations of the subject technology.

FIG. 6 illustrates an electronic device receiving a noise notification from another electronic device while being located in a bag of a user in accordance with one or more implementations of the subject technology.

FIG. 7 illustrates an example alert including a recommendation to don ear protection in accordance with implementations of the subject technology.

FIG. 8 illustrates a flow diagram for an example process for inter-device audio alerts in accordance with implementations of the subject technology.

FIG. 9 illustrates a flow diagram for another example process for inter-device audio alerts in accordance with implementations of the subject technology.

FIG. 10 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Aspects of the disclosure provide for alerts of a noisy environment using an electronic device of a first user, based on a noise notification from a device of a second, different user. The alert may be an alert of a noise level that is above a noise threshold considered safe for continued human immersion (e.g., a noise level, above which may cause temporary or permanent hearing loss either immediately, or over time if exposure continues above that noise level). The noise notification can be wirelessly transmitted (e.g., using Bluetooth or another direct wireless communications protocol) from the device of the second user, and configured for detection by any other devices that are capable of receiving transmissions using the same wireless protocol and that are within a range of the wireless transmission.

In one or more implementations, the electronic device of the first user may locally obtain an audio sample responsive to receiving a noise notification from another device, and confirm, based on the audio sample, a noise level of the environment before providing the alert. In some use cases, an electronic device receiving one or more noise notifications can be in a container, such as a pocket or a bag, when the noise notification(s) is/are wirelessly received from another device. In these or other use cases, the audio sample may be compared to a noise threshold that is lower than a noise threshold used by the transmitting device(s) to trigger the noise notification(s). In some examples, an electronic device receiving a noise notification from another device may wait to obtain the audio sample, and/or to provide the alert, until a threshold number of noise notifications have been received from other devices and/or until the user of the electronic device engages with the electronic device (e.g., by removing the device from the user's pocket or bag).

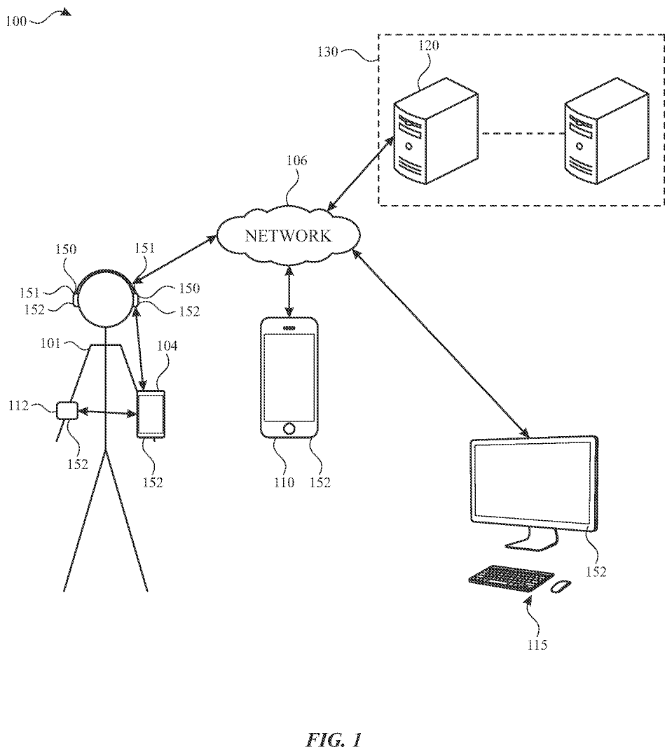

FIG. 1 illustrates an example system architecture 100 including various electronic devices that may implement the subject system in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The system architecture 100 includes an audio device 150, an electronic device 104 (e.g., a handheld electronic device such as a smartphone, a tablet, or a smart watch), an electronic device 110, an electronic device 112 (e.g., a wearable electronic device, such as a smart watch or a head mountable device), an electronic device 115, and one or more servers 120 communicatively coupled by a network 106 (e.g., a local or wide area network). For explanatory purposes, the system architecture 100 is illustrated in FIG. 1 as including the audio device 150, the electronic device 104, the electronic device 110, the electronic device 112, the electronic device 115, and the server 120; however, the system architecture 100 may include any number of electronic and/or audio devices and any number of servers or a data center including multiple servers.

The audio device 150 may be implemented as an audio device such as headphones (e.g., a pair of speakers mounted in speaker housings that are coupled together by a headband), or an earbud (e.g., an earbud of a pair of earbuds, each having a speaker disposed in a housing that conforms to a portion of the user's ear) configured to be worn by a user (also referred to as a wearer when the audio device is worn by the user), or may be implemented as any other device capable of obtaining audio with one or more microphones and/or outputting audio, video and/or other types of media (e.g., and configured to be worn by a user). Each audio device 150 may include one or more speakers, such as speaker 151, configured to project sound into an ear of the user 101, and one or more microphones, such as microphone 152, configured to receive audio input such as external noise input and/or external voice inputs. In one or more implementations, the audio device 150 may include multiple microphones 152 that can be co-operated to form a beamforming microphone array for obtaining sound preferentially from a particular direction and/or location.

As shown in FIG. 1, the electronic device 104, the electronic device 110, the electronic device 112, and the electronic device 115 may also each include one or more microphones 152 for obtaining audio from a physical environment around that device. The electronic device 104, the electronic device 110, the electronic device 112, the electronic device 115 may also include other components not visible in FIG. 1, including, but not limited to, processing circuitry, memory, a display for displaying electronic information visually, haptic components for generating haptic outputs (e.g., vibrations) from one or more portions of the device, communications circuitry (e.g., including wireless communications circuitry), input components, and/or output components.

Although not visible in FIG. 1, each audio device 150 may include processing circuitry (e.g., including memory and/or one or more processors, such as a central processing unit and/or one or more digital signal processors (DSPs)) and communications circuitry (e.g., one or more antennas, etc.) for receiving and/or processing audio content, such as from one or more of the electronic device 104 or the electronic device 112. The processing circuitry of the audio device 150 or another device may operate one or more speakers, such as the speaker 151, to generate sound. The memory may store one or more machine learning models implemented as neural networks and trained for one or more audio processing operations for the audio device 150.

The audio device 150, the electronic device 104, the electronic device 110, the electronic device 112, and/or the electronic device 115 may each include communications circuitry for communications (e.g., directly or via network 106) with others of the audio device 150, the electronic device 104, the electronic device 110, the electronic device 115, and/or the server 120, the communications circuitry including, for example, one or more wireless interfaces, such as WLAN radios, cellular radios, Bluetooth radios, Zigbee radios, near field communication (NFC) radios, and/or other wireless radios. The audio device 150, the electronic device 104, the electronic device 110, the electronic device 112, and/or the electronic device 115 may each include a power sources such as a battery and/or a wired or wireless power source.

The electronic device 104 may be, for example, a smartphone, a portable computing device such as a laptop computer, a peripheral device (e.g., a digital camera, headphones, another audio device, or another media output device), a tablet device, a wearable device such as a smart watch, a smart band, and the like, any other appropriate device that includes, for example, processing circuitry and/or communications circuitry for processing microphone signals including audio content received from the physical environment around the electronic device 104, for generating noise notification advertisements for other electronic devices, for receiving audio data and/or noise notification data from one or more other electronic devices, and/or for generating alerts regarding unsafe noise levels in the physical environment (as examples). In FIG. 1, by way of example, the electronic device 104 is depicted as a mobile smartphone device. In one or more implementations, the electronic device 104 and/or the audio device 150 may be, and/or may include all or part of, the electronic device discussed below with respect to the electronic system discussed below with respect to FIG. 10.

The electronic device 115 may be, for example, desktop computer, a portable computing device such as a laptop computer, a smartphone, a peripheral device (e.g., a digital camera, headphones, another audio device, or another media output device), a tablet device, a wearable device such as a watch, a band, and the like. In FIG. 1, by way of example, the electronic device 115 is depicted as a desktop computer. The electronic device 115 may be, and/or may include all or part of, the electronic system discussed below with respect to FIG. 10.

The electronic device 110 may be, for example, a smartphone, a portable computing device such as a laptop computer, a peripheral device (e.g., a digital camera, headphones, another audio device, or another media output device), a tablet device, a wearable device such as a smart watch, a smart band, and the like, any other appropriate device that includes, for example, processing circuitry and/or communications circuitry for processing microphone signals including audio content received from the physical environment around the electronic device 110, for generating noise notification advertisements for other electronic devices, for receiving audio data and/or noise notification data from one or more other electronic devices, and/or for generating alerts regarding unsafe noise levels in the physical environment (as examples). In FIG. 1, by way of example, the electronic device 110 is depicted as a mobile smartphone device. In one or more implementations, the electronic device 110 may be and/or may include all or part of, the electronic device discussed below with respect to the electronic system discussed below with respect to FIG. 10.

The electronic device 112 may be, for example, a smartphone, a portable computing device such as a laptop computer, a peripheral device (e.g., a digital camera, headphones, another audio device, or another media output device), a tablet device, a wearable device such as a smart watch, a smart band, and the like, any other appropriate device that includes, for example, processing circuitry and/or communications circuitry for processing microphone signals including audio content received from the physical environment around the electronic device 112, for generating noise notification advertisements for other electronic devices, for receiving audio data and/or noise notification data from one or more other electronic devices, and/or for generating alerts regarding unsafe noise levels in the physical environment (as examples). In FIG. 1, by way of example, the electronic device 112 is depicted as a smart watch that is worn on a wrist of the user 101. In one or more implementations, the electronic device 112 may be and/or may include all or part of, the electronic device discussed below with respect to the electronic system discussed below with respect to FIG. 10.

In one or more implementations, the electronic device 104, the audio device 150, and/or the electronic device 112 may be associated with the same user account (e.g., the electronic device 104, the audio device 150, and/or the electronic device 112 may be registered, such as at the servers 120, to a user account of the user 101). In one or more implementations, the electronic device 110 may be associated with a different user account (e.g., the electronic device 110 may be registered to a second user account of a second user, different from the user 101). The electronic device 110 may be unassociated with the user account of the user 101 and/or any other user accounts associated with the user 101, in one or more implementations. In one or more implementations, the electronic device 104, the audio device 150, and/or the electronic device 112 may communicate directly with each other using secure (e.g., encrypted, such as using information that is accessible only to devices associated with the user account of the user 101) communications that are not detectable and/or not decipherable by other devices in proximity to the electronic device 104, the audio device 150, and/or the electronic device 112. In one or more implementations, the electronic device 104, the audio device 150, and/or the electronic device 112 may receive and/or broadcast public (e.g., unencrypted) communications to other devices not associated with the same user account. In one or more implementations, the electronic device 110 may receive and/or broadcast public (e.g., unencrypted) communications to other devices not associated with the same user account.

The server 120 may form all or part of a network of computers or a group of servers 130, such as in a cloud computing or data center implementation. For example, the server 120 stores data and software, and includes specific hardware (e.g., processors, graphics processors and other specialized or custom processors) processing graphics, images, video, audio and/or multi-media files. In an implementation, the server 120 may function as a cloud storage server.

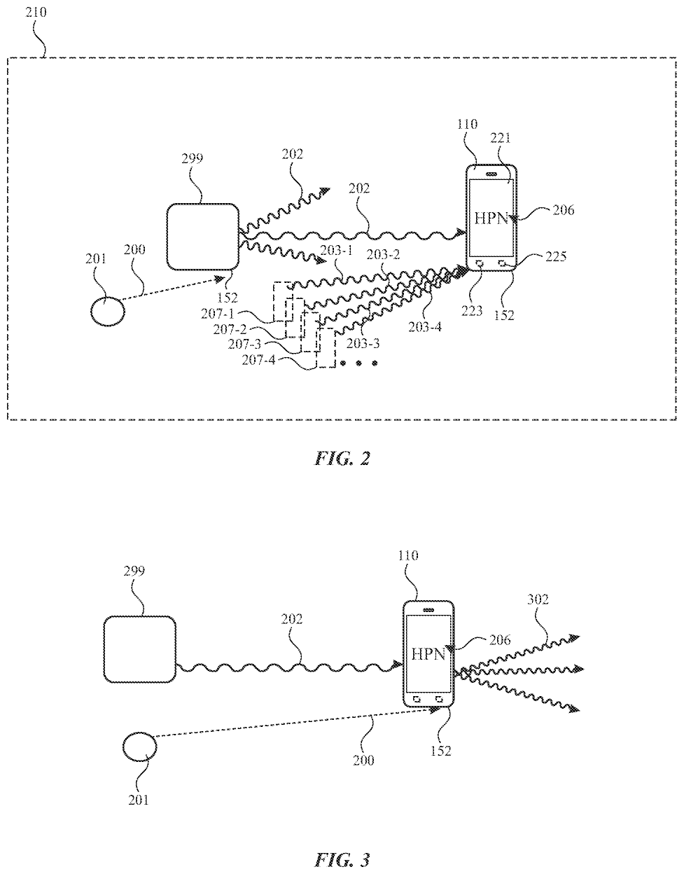

FIG. 2 illustrates an example noise environment 210 in which an electronic device 299 (e.g., a smart watch, such as the electronic device 112, or a smartphone, such as the electronic device 104) and the electronic device 110 (e.g., registered to different respective user accounts of different respective users) may be located. For example, the noise environment 210 may be a physical environment in which one or more sound sources, such as sound source 201 are generating sound. The noise environment 210 may be an indoor environment that is substantially enclosed by walls, doors, and/or windows, or may be an outdoor environment. For example, indoor noise environments may include restaurants, bars, clubs, arenas, theaters, buildings, rooms, factories, vehicles, watercraft, aircraft, shopping malls, warehouses, and/or any other indoor venue in which one or more sources of sound are located. As examples, outdoor noise environments may include stadiums, theaters, concert venues, sporting events, auto racing events, airports, highways, parks, parking lots, parking garages, streets, sidewalks, and/or any other outdoor, open-air, unenclosed, or partially unenclosed environment in which one or more sources of sound are located.

Although a sound source 201 is depicted in FIG. 2, it is appreciated that the noise environment 210 may include one sound source, two source sound sources, more than two sound sources, tens of sound sources, hundreds of sound sources, thousands of sound sources, or any other number of sound sources that individually and cumulatively contribute to the sound level at any particular location within the noise environment 210. As examples, the sound source 201 may be a person, a speaker, a machine, a vehicle, an aircraft, a watercraft, a siren, a crowd of people, a megaphone, a bullhorn, an appliance, and/or any other sound-generating device, component, object, and/or being.

As shown in FIG. 2, a sound source such as the sound source 201 may generate sound 200 that is received a microphone 152 of the electronic device 299. Although not depicted in FIG. 2, the sound 200 may also be received at the ears of the user (e.g., user 101) of the electronic device 299, and at the ears of a user of the electronic device 110. For example, the user 101 may be holding, carrying, or wearing the electronic device 299 while the sound 200 is being generated in the noise environment 210. As illustrated in FIG. 2, the electronic device 299 may broadcast (e.g., transmit), responsive to receiving the sound 200 with the microphone 152 thereof, a noise notification 202. For example, the electronic device 299 may determine that a sound level (e.g., a sound pressure level (SPL), such as in decibels (dB)) exceeds a threshold noise level that is considered safe for human listening, and broadcast the noise notification 202 responsive to that determination.

For example, the threshold noise level may be eighty dB, eight-five dB, ninety dB, ninety-five dB, one hundred dB, or another threshold noise level. In one or more implementations, sound level that is compared to the threshold noise level may be determined by the electronic device 299 over a period of time. In one or more implementations, the period of time may depend on the decibel level of the threshold. As examples, the threshold noise level may be eighty dB for a period of several hours, eight-five dB for a period of one to two hours, ninety dB for a period of between fifteen minutes and one hour, ninety-five dB for a period of five minutes to fifteen minutes, one hundred dB for a period of one to five minutes, or another threshold noise level for another respective period of time.

In one or more implementations, the noise notification 202 may be generated in the form of a wireless advertisement using a corresponding wireless communication protocol. For example, the wireless advertisement may be a Bluetooth advertisement that is configured to be detectable and processable by any device having (e.g., up to date) Bluetooth communications circuitry and that is within the range of Bluetooth communications (e.g., within about twenty to fifty feet). For example, a Bluetooth advertisement may be transmitted over a primary advertising channel and/or a secondary advertising channel in the Bluetooth bands, and may include a preamble, an access address, a protocol data unit (PDU), and or check bits (e.g., cyclic redundancy check (CRC) bits). For example, the PDU may include a header and a payload. In one or more implementations, noise notification information (e.g., including a sound level and/or a period of time) may be included in the header and/or the payload of the wireless advertisement. As another example communication protocol that can be used for noise notifications, the wireless advertisement may be a wireless advertisement generated using a WiFi protocol and that is configured to be detectable and processable by any device having (e.g., up to date) WiFi communications circuitry and that is within the range of WiFi communications (e.g., within about one hundred to three hundred meters).

In one or more implementations, the noise notification may be transmitted using multiple wireless communication protocols (e.g., Bluetooth and direct WiFi). For example, in one or more implementations, the electronic device 299 may select a wireless communications protocol based on a sound level detected by the electronic device 299 (e.g., a shorter range wireless communications protocol, such as Bluetooth, may be used for relatively lower SPLs, such as SPLs less than ninety five dB, and a longer range wireless communications protocol, such as direct WiFi, may be added to the shorter range notification for relatively higher SPLs, such as SPLs greater than ninety five dB that may affect users at greater distances from the electronic device 299).

As shown in FIG. 2, responsive to receiving the noise notification 202 (e.g., wirelessly and directly from the electronic device 299), the electronic device 110 may provide an alert 206, such as a hearing protection notification (HPN). As examples, the alert 206 may be provided using a display 221 of the electronic device 110, using a speaker 223 of the electronic device 110, and/or using a haptic component 225 of the electronic device 110 (e.g., to vibrate the electronic device 110 to provide a notification that may be received by a user of the electronic device 110 even in a loud environment, and/or even while the user is not looking at or engaging with the electronic device 110).

As shown, one or more other electronic devices, such as electronic devices 207-1, 207-2, 207-3, and 207-4 may also be located within the noise environment 210. For example, each of the electronic devices 207-1, 207-2, 207-3, and 207-4 may be a smartphone or a smart watch of a different respective user that is in the noise environment 210 with the user of the electronic device 299 and the user of the electronic device 110. As examples, the users of the electronic device 299, the electronic device 110, and electronic devices 207-1, 207-2, 207-3, and 207-4 may be coworkers in a building or a factory, attendees of a concert, a show, or a sporting event, or patrons at a restaurant, a club, or other business.

The electronic device 110 may provide the alert 206 responsive only to the noise notification 202, in some implementations. In one or more other implementations, the electronic device 110 may receive the noise notification 202 and may provide the alert 206 responsive to receiving the noise notification 202 and responsive to one or more other criteria. As one example criterion, the electronic device 110 may cache multiple noise notifications and may provide the alert 206 responsive to receiving a threshold number of noise notifications (e.g., at least two noise notifications, at least three noise notifications, at least four noise notifications, or at least five noise notifications), such as within a predetermined window of time (e.g., within one minute, within three minutes, within five minutes, or within ten minutes). For example, as illustrated in FIG. 2, the electronic device 110 may receive the noise notification 202 from the electronic device 299, and may receive one or more other noise notifications, such as noise notifications 203-1, 203-2, 203-3, and 203-4, (e.g., directly and wirelessly) from one or more other devices, such as electronic devices 207-1, 207-2, 207-3, and 207-4 respectively that are located within the noise environment 210.

As another example criterion, the electronic device 110 may, responsive to receiving the noise notification 202 and/or one or more other noise notifications from one or more other devices, locally confirm the noise level using a microphone of the electronic device 110 before providing the alert 206. For example, FIG. 3 illustrates an example use case in which the electronic device 110 receives the noise notification 202 (from the electronic device 299), and also receives (e.g., a portion of) the sound 200 from the sound source 201 at the microphone 152 of the electronic device 110. The electronic device 110 may then obtain an audio sample of the sound 200, and compare a sound level in the audio sample to a threshold noise level. In one or more implementations, the electronic device 110 may provide the alert responsive to receiving the noise notification 202 (e.g., and/or one or more noise notifications) and responsive to determining that the noise level in the audio sample exceeds the threshold noise level (e.g., thereby confirming that the noise level in the noise environment 210, such as at the location of the electronic device 110 and/or the user thereof, is above a safe listening threshold).

FIG. 3 also illustrates how the electronic device 110 may (e.g., upon receiving the noise notification 202, and/or upon confirming the noise level by comparing a locally obtained sound level with a confirmatory threshold noise level), in addition to providing the alert 206 to the user of the electronic device 110, also broadcast a noise notification 302 (e.g., that can be detected by one or more other devices within the range of the wireless protocol used to generate the noise notification 302). As with the noise notification 202 from the electronic device 299, the noise notification 302 may include (e.g., in a header portion or in a payload portion of a wireless advertisement) a sound level detected by the electronic device and/or a time over which the sound level was detected. In this way, the electronic device 110 can join in the noise notifications being broadcast by other devices, and add to the density of electronic devices providing noise notifications to other devices within the noise environment 210. Increasing the density in this way may increase the confidence with which receiving electronic devices can provide alerts to their own users to obtain and/or don hearing protection. In one or more implementations, the noise notifications that are broadcast by various electronic devices can be synchronized in time (e.g., by broadcasting the noise notifications at the beginning of a minute, as tracked by a global or common time source). In this way, the electronic devices can avoid, for example, cascading waves of notifications within a crowd of people having electronic devices.

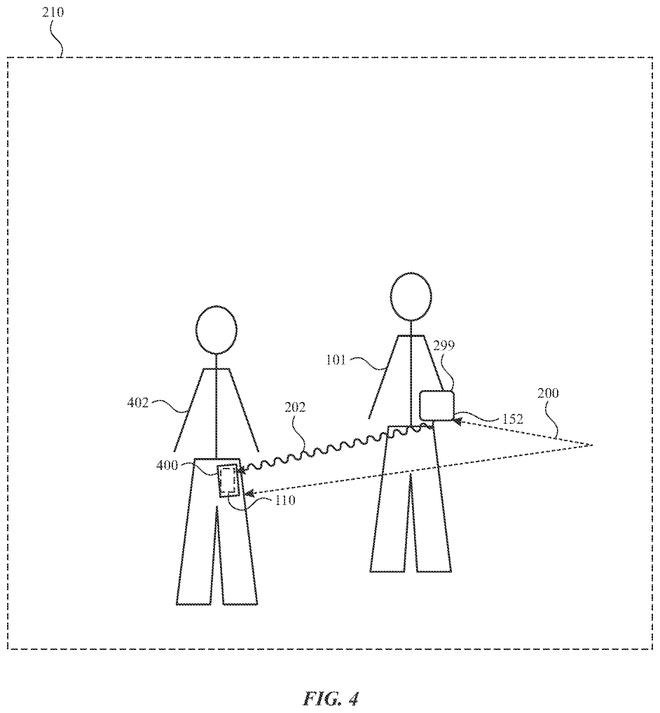

In various implementations, the (e.g., confirmatory) threshold noise level to which the electronic device 110 compares the sound level in the audio sample obtained using its own microphone(s) may be the same as the threshold noise level to which the electronic device 299 compares the sound level to trigger the noise notification 202, or may be a different threshold noise level. For example, there are many use cases in which the electronic device 104 may detect a sound level in the noise environment 210 that is above a safe threshold, while the microphone 152 of the electronic device 110 is occluded or otherwise prevented from receiving the full sound within the noise environment 210. For example, FIG. 4 illustrates an example use case in which the electronic device 299 is being carried or worn by the user 101, while the electronic device 110 of another user 402 is in a pocket 400 of the other user 402 (e.g., another user having a user account to which the electronic device 110 is registered).

In this example use case, the sound 200 that reaches the microphone of the electronic device 110 may be reduced relative to the sound 200 that reaches the microphone 152 of the electronic device 299, and the noise notification 202 may be used to notify the electronic device 110 of a high sound level in the noise environment 210 that may be undetectable by the electronic device 110 while in the pocket 400. In this example use case, the electronic device 110 may, in some implementations, obtain an audio sample (e.g., as in the example of FIG. 3) while the electronic device 110 is in the pocket 400, and may compare the sound level in the audio sample to a threshold noise level that is lower than the threshold noise level used by the electronic device 104 to trigger the noise notification 202.

The electronic device 110 may then provide an alert 206, such as a haptic alert, for the user 402 responsive to determining that the sound level in the audio sample exceeds the lower threshold noise level. In this way, the noise notification 202 from the electronic device 299 of the user 101 with an un-occluded microphone may be used to alert another, unassociated, user 402 of a potentially dangerous sound level in the noise environment 210, even when that potentially dangerous sound level is (e.g., temporarily) undetectable by the electronic device 110 itself. Although a single other user (e.g., user 402) with a single other device (e.g., electronic device 110) is depicted in FIGS. 2-4 for simplicity of the present description, it is appreciated that the noise notification 202 may be broadcast from the electronic device 299 to multiple (e.g., many) other devices, to trigger (e.g., along with noise notifications from one or more further other electronic devices) a noise alert at each of the multiple (e.g., many) other devices.

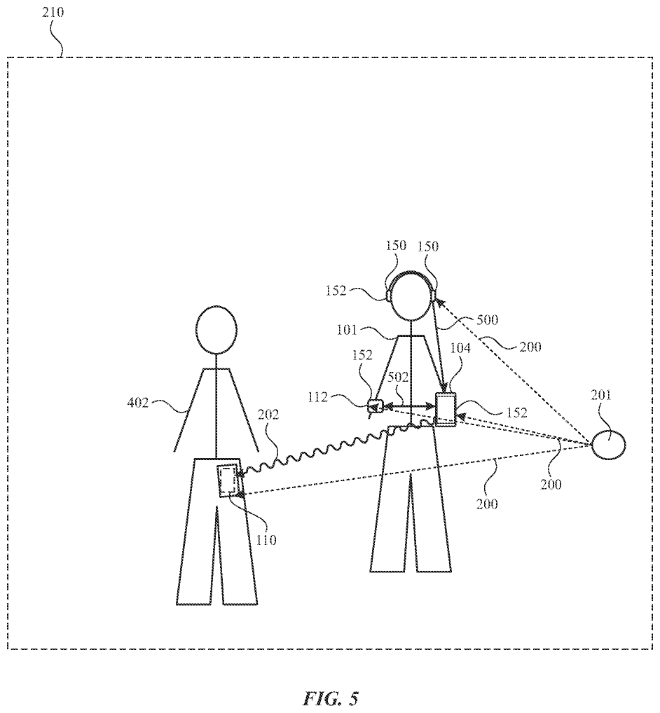

In the examples of FIGS. 3 and 4, the sound level in the noise environment 210 is detected directly by the electronic device 299 (e.g., one of the electronic device 104 or the electronic device 112) prior to generating and broadcasting the noise notification 202. It is also appreciated that the sound level in the noise environment 210 may be detected by one or more other devices (e.g., the other of the electronic device 104 or the electronic device 112, and/or the audio device 150) that are associated with the same user account as the user account to which the electronic device 104 is associated, prior to the electronic device 299 broadcasting the noise notification 202. For example, FIG. 5 illustrates an example use case in which the user 101 of the electronic device 104 is wearing a smart watch (e.g., electronic device 112) while in the noise environment 210. In one or more implementations, the smart watch may detect (e.g., using the microphone 152 thereof) a sound level above a threshold noise level, and may provide a (e.g., encrypted) notification 502 to the electronic device 104. The electronic device 104 may then broadcast the noise notification 202 responsive to receiving (e.g., and decrypting) the notification 502 of the sound level from the smart watch. This noise detection using a smart watch can be beneficial since a smart watch may be less likely to be kept within a pocket, a bag, or other container than a smart phone implementation of the electronic device 104, and may therefore be more likely to be able to detect the full sound level in the noise environment 210. This noise detection using a smart watch can also be beneficial for power management and/or optimization. For example, a smart watch may run an audio analysis in the background and send an advertisement (e.g., a notification 502, such as a Bluetooth advertisement) when a sound level above a threshold is reached. Nearby smartphones can cache and eventually (e.g., when a threshold number of other advertisements are received) act on this advertisement from the smart watch (e.g., to provide an alert), allowing the nearby smartphones to provide alerts without having to run their own (e.g., always on) audio analysis. For example, the nearby smartphones may each run only a quick local check on the sound level responsive to receiving the notification from the smart watch (e.g., and one or more or many other smart watches), thus significantly reducing battery impact on the nearby smart phones.

In the example of FIG. 5, the user 101 of the electronic device 104 is also wearing earbuds or headphones (e.g., audio device 150) while in the noise environment 210. In one or more implementations, earbuds or headphones may detect (e.g., using the microphone 152 thereof) a sound level above a threshold noise level, and may provide a (e.g., encrypted) notification 500 to the electronic device 104. The electronic device 104 may then broadcast the noise notification 202 responsive to receiving (e.g., and decrypting) the notification 500 of the sound level from the earbuds or headphones. This noise detection using earbuds or headphones can be beneficial since earbuds or headphones may be less likely to be kept within a pocket, a bag, or other container than a smart phone implementation of the electronic device 104, and may therefore be more likely to be able to detect the full sound level in the noise environment 210. In one or more use cases, both the smart watch and the earbuds or headphones of the user 101 may detect a sound level above a threshold noise level, and may provide a notification to the electronic device 104.

In one or more implementations, the notification from the smart watch and/or the earbuds or headphones of the user 101 may be provided to the electronic device 104 of the user 101 using secure (e.g., encrypted) communications that are not decipherable by devices that are not associated with the user account of the user 101. In one or more implementations, the smart watch of the user 101 and/or the earbuds or headphones of the user 101 may also, separately, broadcast noise notifications that are detectable and decipherable by other devices, such as the electronic device 110, that are not associated with the user account of the user 101. However, in one or more implementations, the electronic device 104 may broadcast a single noise notification on behalf of the multiple devices of the user 101 (e.g., without separately broadcasting noise notifications from the smart watch or the earbuds or headphones), so that devices of other users only receive one notification per unit time from the devices of any given user.

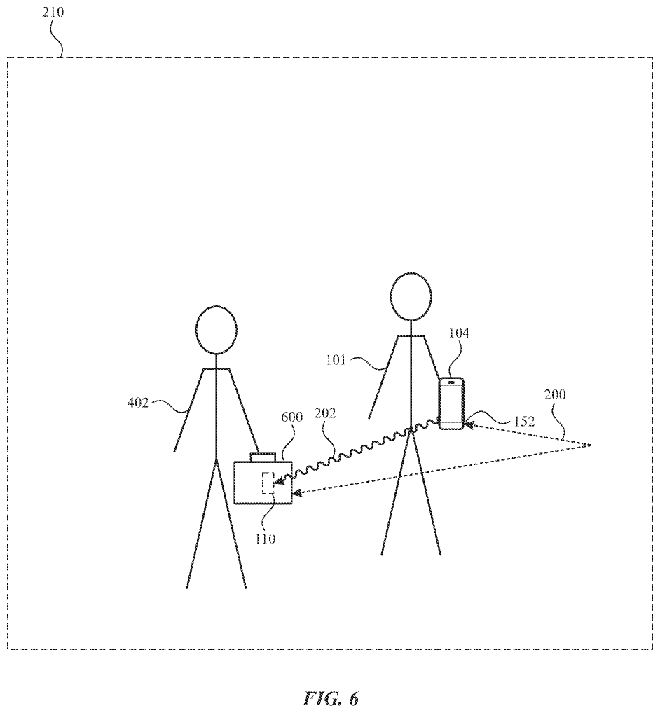

In the examples of FIGS. 4 and 5, electronic device 110 is depicted as being in a pocket 400 of a user 402. However, it is also appreciated that an electronic device, such as the electronic device 110, can be disposed in other types of containers within the noise environment 210. For example, FIG. 6 illustrates another example use case in which the electronic device 110 is disposed in a bag 600 (e.g., a purse, a backpack, a fanny pack, a lunch pail, a suitcase, or other bag) of the user 402. In this example, the sound 200 may be attenuated or partially blocked by the bag 600 from reaching the microphone of the electronic device 110. In this example use case, the noise notification 202 may be used to notify the electronic device 110, within the bag 600, of a high sound level in the noise environment 210 that may be undetectable by the electronic device 110 while in the bag 600. In this example use case, the electronic device 110 may obtain an audio sample (e.g., as in the example of FIG. 3) while the electronic device 110 is in the bag 600, and may compare the sound level in the audio sample to a threshold noise level that is lower than the threshold noise level used by the electronic device 104 to trigger the noise notification 202.

In the examples of FIGS. 4-6, in which the electronic device 110 is in a container (e.g., a pocket 400 or a bag 600) and/or the microphone(s) 152 of the electronic device 110 are occluded, the electronic device 110 may provide an alert 206 immediately in response to the noise notification 202, may cache the noise notification 202 (e.g., and/or one or more additional noise notifications received from one or more additional devices) and provide the alert 206 when the electronic device 110 is removed from the container (e.g., when the user 402 takes their phone out of their pocket 400 or their bag 600) and/or otherwise engaged with by the user 402, or may provide an alert 206 in response to the noise notification 202 and one or more additional criteria for waking the electronic device 110.

For example, while in a pocket 400, a bag 600, or another container, the electronic device 110 may be in an inactive state (e.g., a sleep state, such as a state in which a primary processor of the electronic device 110 is inactive). In the inactive state, a secondary processor (e.g., an always-on processor having fewer computing and/or memory resources than a primary processor of the electronic device) may have the ability to cache and/or process one or more noise notifications from one or more other devices, without waking the primary processor of the electronic device 110. In one or more implementations, the electronic device 110 can cache any noise notifications received from any other devices until the user engages with the electronic device 110 to wake the electronic device 110, and can provide an alert 206 upon the user's waking of the electronic device 110. Because hearing loss typically occurs over extended periods of noise exposure, waiting to provide an alert can still be beneficial to a user, even if the alert is not seen by the user until several minutes after the noise notification 202 is received. This can be particularly beneficial, for example, in resource-constrained devices, such as a portable devices that are powered by batteries, and for which power consumption by waking a device to provide alerts that are not immediately received by the user can be undesirable.

However, in one or more implementations, one or more criteria may be applied, while the electronic device 110 is in an inactive state, to determine whether to wake the electronic device 110 to provide the alert 206. For example, the electronic device 110 may wake from an inactive state (e.g., by activating a primary processor of the electronic device 110) to provide an alert 206 responsive to receiving a threshold number of noise notifications from a threshold number of other devices. For example, receiving a threshold number of noise notifications may serve as a confirmation to the electronic device 110 that the alert 206 may be immediately beneficial to the user thereof. As another example, the electronic device 110 may wake from an inactive state, to provide an alert 206, responsive to receiving a noise notification 202 that includes a sound level that is above a wake threshold sound level. For example, the wake threshold sound level (e.g., ninety dB or ninety five dB) may be higher than the threshold noise level used by the electronic device 104 (e.g., and/or one or more other devices) to trigger broadcasting a noise notification. In this way, a device can be woken up to provide an alert 206, when the time before hearing damage occurs is less than, for example, a few minutes.

In one example use case, a noise notification 202 may include an indication that the sound level detected by the electronic device 104 is eighty decibels. In this example use case, because hearing loss may not occur for a user of the electronic device 110 for several hours, the electronic device 110 may remain in an inactive state, and may provide an alert 206 corresponding to the noise notification 202 when the user later engages with the electronic device 110 to wake the electronic device 110. In another example use case, a noise notification 202 may include an indication that the sound level detected by the electronic device 104 is ninety-five decibels. In this example use case, because hearing loss may occur for a user of the electronic device 110 within minutes, the electronic device 110 may automatically wake from an inactive state to provide an alert 206 (e.g., even if the electronic device is within a container such as a pocket 400, or a bag 600). For example, in this example use case, the alert 206 may include a haptic output of the electronic device 110 that attempts to gain the users attention from within a container.

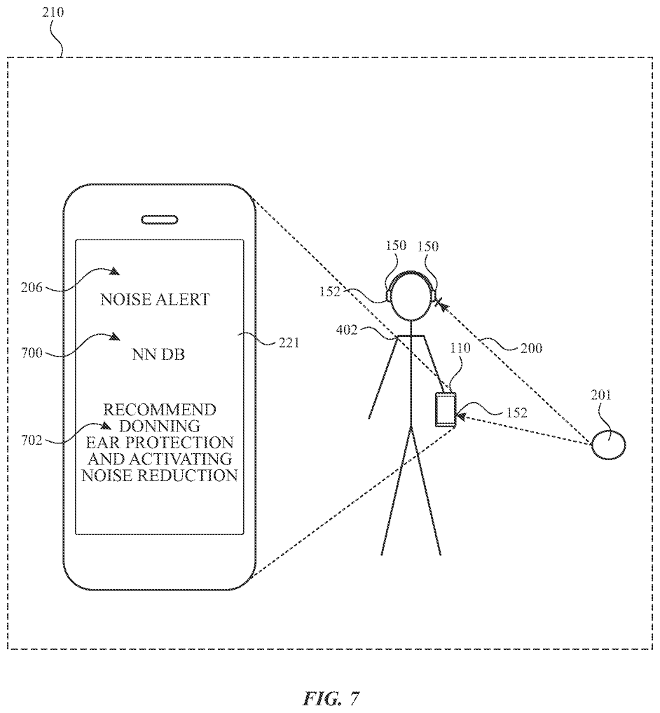

FIG. 7 illustrates an example alert 206 that may be provided by the electronic device 110 (e.g., in response to receiving a noise notification 202 from the electronic device 104, and/or one or more other noise notifications from one or more other devices). As illustrated in FIG. 7, the alert 206 may include text displayed on a display of the electronic device 110. As shown, the text may include an indication that the alert is a noise alert, a sound level 700, and a recommendation 702. In this example, the sound level 700 is reported in decibels. In one or more implementations, the sound level 700 may be a sound level that has been received by the electronic device 110 in a noise notification 202 (e.g., in a payload of the noise notification or in a header of the noise notification) from the electronic device 104. In one or more other implementations, the sound level 700 may be a sound level determined at the electronic device 110 based on an audio sample captured by the electronic device 110 in response to receiving the noise notification 202.

As shown in FIG. 7, the recommendation 702 that is included in the alert 206 may include a recommendation to don (e.g., put on) ear protection. As shown, the recommendation 702 may also include a recommendation to activate noise reduction operations using an active ear protection device. For example, as shown in FIG. 7, responsive to receiving the alert 206 via the electronic device 110, the user 402 may don ear protection, such as earplugs or an audio device 150, such as earbuds or headphones. In one or more implementations, the earbuds or headphones may include one or more microphones, one or more speaker(s), and one or more processors capable of performing active noise cancellation (ANC) operations using microphone(s) and the speaker(s) thereof. As indicated in FIG. 7, the active noise cancellation operations of the audio device 150 may actively block or otherwise prevent some or all of the sound 200 from reaching the user's ear. In one or more implementations, the audio device 150 may automatically increase or decrease the amount of noise cancellation based on respective increases or decreases in the sound level in the noise environment 210.

In one or more implementations, prior to providing the alert 206, the electronic device 110 may determine whether any active ear protection devices (e.g., audio device 150) is nearby, paired with, and/or connected to (e.g., via a wired or wireless connection) to the electronic device 110. If such an active ear protection device is detected, the recommendation 702 may include a recommendation to don the detected active ear protection device. If such an active ear protection device is not detected, the recommendation 702 may include a recommendation to seek inactive hearing protection, such as earplugs.

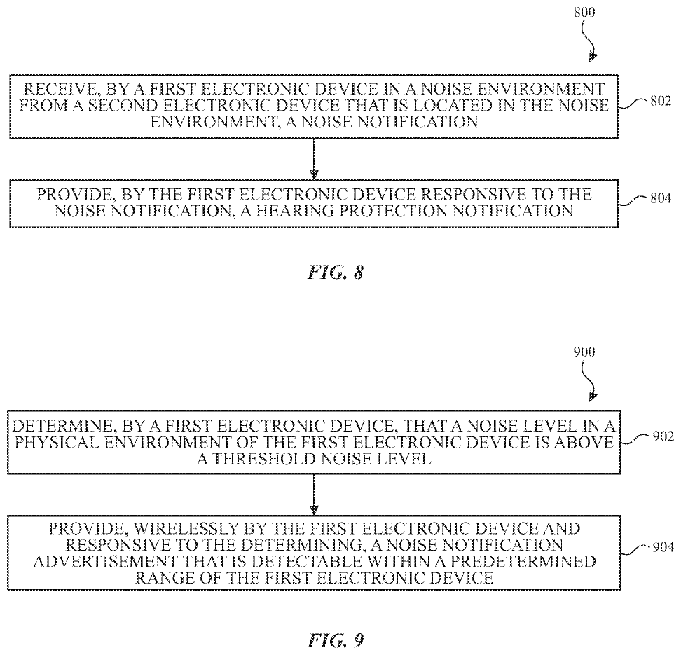

FIG. 8 illustrates a flow diagram of an example process 800 for inter-device audio alerts, in accordance with implementations of the subject technology. For explanatory purposes, the process 800 is primarily described herein with reference to the electronic device 104 and the electronic device 110 of FIGS. 1-3. However, the process 800 is not limited to the audio device 150 and electronic device 104 of FIGS. 1-3, and one or more blocks (or operations) of the process 800 may be performed by one or more other components of other suitable devices, including the electronic device 110, the electronic device 112, the electronic device 115, and/or the servers 120. Further for explanatory purposes, some of the blocks of the process 800 are described herein as occurring in serial, or linearly. However, multiple blocks of the process 800 may occur in parallel. In addition, the blocks of the process 800 need not be performed in the order shown and/or one or more blocks of the process 800 need not be performed and/or can be replaced by other operations.

As illustrated in FIG. 8, at block 802, a first electronic device (e.g., electronic device 110) in a noise environment (e.g., noise environment 210) may receive (e.g., directly and wirelessly), from a second electronic device (e.g., a first other device, such as electronic device 104) that is located in the noise environment, a noise notification (e.g., noise notification 202). For example, the noise notification may have been broadcast from the second electronic device that is located in the noise environment. The first electronic device may be associated with (e.g., registered to) a first user account, and the second electronic device may be associated with (e.g., registered to) a second user account different from the first user account (e.g., and may be unassociated with, such as not registered to and/or not logged into, the first user account). In one or more implementations, the noise notification may be a first noise notification and the first electronic device may also receive, directly and wirelessly from a third electronic device (e.g., a second other device, such as electronic device 207-1), a second noise notification. As discussed herein in connection with FIG. 2, one or more additional noise notifications may also be received from one or more additional respective other devices.

In one or more implementations, the first electronic device may determine, responsive to wirelessly receiving at least the noise notification, a first noise level in the noise environment. For example, determining the first noise level may include obtaining, with a microphone (e.g., microphone 152) of the first electronic device responsive to receiving the noise notification, an audio sample of the noise environment; obtaining the first noise level from the audio sample; and comparing the first noise level to the threshold noise level.

In one or more implementations, the threshold noise level may be a first threshold noise level that is lower than a second threshold noise level used by the second electronic device to trigger broadcasting the noise notification. For example, the lower first threshold noise level may allow the first electronic device to confirm a potentially unsafe noise level indicated by the noise notification, even if a microphone of the first electronic device is occluded (e.g., by a container, such as a bag or a pocket, in which the first electronic device is located when the noise notification is received, in some use cases).

In one or more implementations, the noise notification may include a wireless advertisement (e.g., a Bluetooth advertisement or a direct WiFi advertisement) corresponding to a second noise level measured by the second electronic device in the noise environment. The wireless advertisement may include an indication of the second noise level (e.g., in a header or a payload of the wireless advertisement). The indication of the second noise level may include an indication of the second noise level and a period of time corresponding to a measurement of the second noise level (e.g., ninety dB sustained over ten seconds, thirty seconds, one minute, or three minutes).

In one or more implementations, the noise notification may be a first noise notification, and the first electronic device may determine the first noise level responsive to receiving at least the first noise notification from the second electronic device that is located in the noise environment and a second noise notification broadcast from a third electronic device (e.g., electronic device 207-1) that is located in the noise environment. For example, determining the first noise level may include determining the first noise level responsive to receiving the noise notification from the second electronic device and at least one additional noise notification from at least one additional electronic device. In one or more implementations, the process 800 may also include broadcasting, by the first electronic device, a third noise notification (e.g., noise notification 302) configured for detection within a predetermined range of the first electronic device.

At block 804, the first electronic device may provide (e.g., responsive to receiving the noise notification, and/or responsive to determining that the first noise level is above the threshold noise level) an alert (e.g., alert 206, such as a hearing protection notification). The alert may include a recommendation (e.g., recommendation 702) to obtain hearing protection (e.g., earplugs, earbuds, or headphones, such as audio device 150). In one or more implementations, the first electronic device may provide, responsive to receiving at least the first noise notification and the second noise notification (e.g., with or without determining the first noise level and/or comparing the first noise level to a threshold noise level responsive to receiving at least the first noise notification and the second noise notification), the alert. The alert may indicate a noise level (e.g., sound level 700) above a predetermined safety level (e.g., eighty dB, eighty five dB, ninety dB, ninety five dB, or one hundred dB).

In one or more implementations, the alert may include a notification on a display (e.g., display 221) of the first electronic device. The alert may also, or alternatively, include a haptic output by the first electronic device (e.g., by a haptic component 225 of the first electronic device).

In one or more implementations, the recommendation includes a recommendation to don a hearing protection device. In one or more implementations, the first electronic device may determine that an active hearing protection device (e.g., an audio device 150 that is registered to the same user account as the first electronic device, such as an earbud or headphones) is wirelessly connected to the first electronic device, and the recommendation may include a recommendation to don the active hearing protection device. In one or more implementations, the process 800 may also include reducing an amount of noise received at an ear of a user of the first electronic device using the active hearing protection device (e.g., by performing an ANC operation with the active hearing protection device).

In one or more implementations, the first electronic device may provide the alert responsive to receiving the at least the noise notification (e.g., responsive to receiving at least a first noise notification from a first other device and a second noise notification from a second other device) by: determining that a microphone of the first electronic device is in a container (e.g., pocket 400 or bag 600) within the noise environment in which the first electronic device, the first other device, and the second other device are located; and providing the alert responsive to receiving at least the first noise notification and the second noise notification and responsive to determining, by the first electronic device (e.g., using one or more sensors, such as an accelerometer and/or an ambient light sensor, and/or one or more cameras of the first electronic device), that the first electronic device has been removed from the container.

In one or more implementations, the first electronic device may receive the noise notification and/or one or more additional noise notifications (e.g., a first noise notification from a first other device and a second noise notification from a second other device) while the first electronic device is in an inactive state; and may provide the alert responsive to receiving the noise notification and/or one or more additional noise notifications (e.g., at least the first noise notification and the second noise notification) by: determining, while the first electronic device is in the inactive state, that a noise level indicated in the noise notification and/or one or more additional noise notifications (e.g., indicated in the first noise notification, indicated in the second noise notification, or indicated in both the first noise notification and the second noise notification) is greater than a threshold noise level (e.g., a wake threshold level, which may be higher than a threshold noise level used by the second electronic device to trigger sending the noise notification); and waking the first electronic device from the inactive state to provide the alert responsive to determining that the noise level indicated in the noise notification and/or one or more additional noise notifications is greater than the threshold noise level.

In one or more implementations, the first electronic device may receive the noise notification and/or one or more additional noise notifications (e.g., a first noise notification from a first other device and a second noise notification from a second other device) while the first electronic device is in an inactive state; and may provide the alert responsive to receiving the noise notification and/or one or more additional noise notifications (e.g., at least the first noise notification and the second noise notification) by: determining, while the first electronic device is in the inactive state, that a number of noise notifications (e.g., including the first noise notification and the second noise notification) received by the first electronic device is greater than a threshold number of noise notifications; and waking the first electronic device from the inactive state to provide the alert responsive to determining that the number of noise notifications is greater than the threshold number of noise notifications.

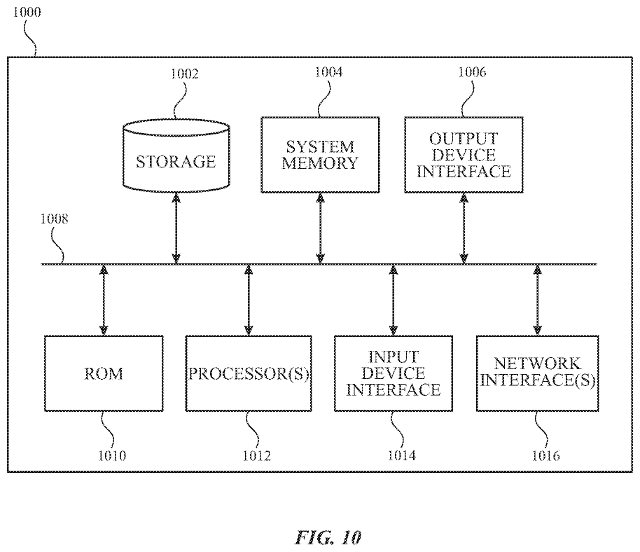

FIG. 9 illustrates a flow diagram of another example process 900 for inter-device audio alerts, in accordance with implementations of the subject technology. For explanatory purposes, the process 900 is primarily described herein with reference to the audio device 150 and electronic device 104 of FIGS. 1-3. However, the process 900 is not limited to the audio device 150 and electronic device 104 of FIGS. 1-3, and one or more blocks (or operations) of the process 900 may be performed by one or more other components of other suitable devices, including the electronic device 110, the electronic device 115, and/or the servers 120. Further for explanatory purposes, some of the blocks of the process 900 are described herein as occurring in serial, or linearly. However, multiple blocks of the process 900 may occur in parallel. In addition, the blocks of the process 900 need not be performed in the order shown and/or one or more blocks of the process 900 need not be performed and/or can be replaced by other operations.

As illustrated in FIG. 9, at block 902, a first electronic device (e.g., electronic device 104) may determine that a noise level in a physical environment (e.g., noise environment 210) of the first electronic device is above a threshold noise level. For example, the first electronic device may obtain (e.g., using one or more microphones 152 thereof) one or more audio samples of the physical environment and may compare sound levels (e.g., noise levels) in the one or more audio samples to the threshold noise level. In one or more use cases, the first electronic device may be worn by a user or carried by a user while determining that the noise level in the physical environment is above the threshold noise level. The threshold noise level may be a noise level above which temporary or permanent hearing loss or damage may occur if a human ear is exposed at that noise level for a period of time.

At block 904, the first electronic device may broadcast, wirelessly and responsive to the determining, a noise notification advertisement (e.g., noise notification 202) that is detectable within a predetermined range of the first electronic device. For example, the predetermined range may include a range of a wireless communication protocol (e.g., a Bluetooth range or a direct WiFi range). The noise notification advertisement may include information (e.g., sound level 700) indicating the noise level. The noise notification advertisement may include time information indicating a period of time over which the noise level was measured by the first electronic device. The first electronic device may periodically broadcast updated noise notification advertisements while the noise level continues to be above the threshold noise level (e.g., including updated noise level measurements and/or updating timing information for updated noise level measurements). In one or more implementations, the updated noise notification advertisements may include rotating random advertisement addresses, so that the periodically updated noise notification advertisements cannot be used to track the first electronic device.

In one or more implementations, determining that the noise level in the physical environment of the first electronic device is above the threshold noise level may include receiving a noise notification wirelessly from a third electronic device (e.g., audio device 150 and/or electronic device 112) associated with (e.g., registered to) the first user account (e.g., as described herein in connection with FIG. 5). As described herein, the second electronic device may provide an alert (e.g., alert 206) to a user thereof in response to receiving the noise notification advertisement.

As described above, one aspect of the present technology is the gathering and use of data available from specific and legitimate sources for inter-device audio alerts. The present disclosure contemplates that in some instances, this gathered data may include personal information data that uniquely identifies or can be used to identify a specific person. Such personal information data can include audio data, voice samples, voice profiles, demographic data, location-based data, online identifiers, telephone numbers, email addresses, home addresses, biometric data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for inter-device audio alerts.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the example of inter-device audio alerts, the present technology can be configured to allow users to select to “opt in” or “opt out” of participation in the collection and/or sharing of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level or at a scale that is insufficient for facial recognition), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

FIG. 10 illustrates an electronic system 1000 with which one or more implementations of the subject technology may be implemented. The electronic system 1000 can be, and/or can be a part of, the audio device 150, the electronic device 104, the electronic device 110, the electronic device 115, and/or the server 120 as shown in FIG. 1. The electronic system 1000 may include various types of computer readable media and interfaces for various other types of computer readable media. The electronic system 1000 includes a bus 1008, one or more processing unit(s) 1012, a system memory 1004 (and/or buffer), a ROM 1010, a permanent storage device 1002, an input device interface 1014, an output device interface 1006, and one or more network interfaces 1016, or subsets and variations thereof.

The bus 1008 collectively represents all system, peripheral, and chipset buses that communicatively connect the numerous internal devices of the electronic system 1000. In one or more implementations, the bus 1008 communicatively connects the one or more processing unit(s) 1012 with the ROM 1010, the system memory 1004, and the permanent storage device 1002. From these various memory units, the one or more processing unit(s) 1012 retrieves instructions to execute and data to process in order to execute the processes of the subject disclosure. The one or more processing unit(s) 1012 can be a single processor or a multi-core processor in different implementations.

The ROM 1010 stores static data and instructions that are needed by the one or more processing unit(s) 1012 and other modules of the electronic system 1000. The permanent storage device 1002, on the other hand, may be a read-and-write memory device. The permanent storage device 1002 may be a non-volatile memory unit that stores instructions and data even when the electronic system 1000 is off. In one or more implementations, a mass-storage device (such as a magnetic or optical disk and its corresponding disk drive) may be used as the permanent storage device 1002.

In one or more implementations, a removable storage device (such as a floppy disk, flash drive, and its corresponding disk drive) may be used as the permanent storage device 1002. Like the permanent storage device 1002, the system memory 1004 may be a read-and-write memory device. However, unlike the permanent storage device 1002, the system memory 1004 may be a volatile read-and-write memory, such as random access memory. The system memory 1004 may store any of the instructions and data that one or more processing unit(s) 1012 may need at runtime. In one or more implementations, the processes of the subject disclosure are stored in the system memory 1004, the permanent storage device 1002, and/or the ROM 1010 (which are each implemented as a non-transitory computer-readable medium). From these various memory units, the one or more processing unit(s) 1012 retrieves instructions to execute and data to process in order to execute the processes of one or more implementations.

The bus 1008 also connects to the input and output device interfaces 1014 and 1006. The input device interface 1014 enables a user to communicate information and select commands to the electronic system 1000. Input devices that may be used with the input device interface 1014 may include, for example, alphanumeric keyboards and pointing devices (also called “cursor control devices”). The output device interface 1006 may enable, for example, the display of images generated by electronic system 1000. Output devices that may be used with the output device interface 1006 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 10, the bus 1008 also couples the electronic system 1000 to one or more networks and/or to one or more network nodes, such as the electronic device 110 shown in FIG. 1, through the one or more network interface(s) 1016. In this manner, the electronic system 1000 can be a part of a network of computers (such as a LAN, a wide area network (“WAN”), or an Intranet, or a network of networks, such as the Internet. Any or all components of the electronic system 1000 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. The described functionality may be implemented in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention described herein.

The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

The term automatic, as used herein, may include performance by a computer or machine without user intervention; for example, by instructions responsive to a predicate action by the computer or machine or other initiation mechanism. The word “example” is used herein to mean “serving as an example or illustration.” Any aspect or design described herein as “example” is not necessarily to be construed as preferred or advantageous over other aspects or designs.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

What is claimed is:

1. A method, comprising
receiving wirelessly, by a first electronic device in a noise environment, a noise notification from a second electronic device that is located in the noise environment; and
providing, by the first electronic device responsive to the noise notification, a hearing protection notification.

2. The method of claim 1, wherein the noise notification comprises a wireless advertisement corresponding to a noise level measured by the second electronic device in the noise environment.

3. The method of claim 2, wherein the wireless advertisement includes an indication of the noise level.

4. The method of claim 3, wherein the indication of the noise level comprises an indication of the noise level and a period of time corresponding to a measurement of the noise level.

5. The method of claim 1, wherein the hearing protection notification comprises a notification on a display of the first electronic device.

6. The method of claim 1, wherein the hearing protection notification comprises a haptic output by the first electronic device.

7. The method of claim 1, wherein the hearing protection notification comprises a recommendation to don a hearing protection device.

8. The method of claim 7, further comprising determining, by the first electronic device, that an active hearing protection device is wirelessly connected to the first electronic device, and wherein the recommendation comprises a recommendation to don the active hearing protection device.

9. The method of claim 8, further comprising, reducing an amount of noise received at an ear of a user of the first electronic device using the active hearing protection device.

10. The method of claim 8, wherein the active hearing protection device comprises an earbud.

11. The method of claim 1, wherein the noise notification comprises a first noise notification, and wherein providing the hearing protection notification responsive to receiving the noise notification comprises providing the hearing protection notification responsive to receiving at least the first noise notification from the second electronic device that is located in the noise environment and a second noise notification from a third electronic device that is located in the noise environment.

12. The method of claim 11, wherein providing the hearing protection notification responsive to receiving at least the first noise notification from the second electronic device that is located in the noise environment and the second noise notification from the third electronic device that is located in the noise environment comprises providing the hearing protection notification responsive to receiving a number of noise notifications, from a number of respective other devices, that is greater than a threshold number of noise notifications.

13. The method of claim 1, wherein providing the hearing protection notification responsive to receiving the noise notification comprises:
obtaining, by the first electronic device responsive to receiving the noise notification, an audio sample of the noise environment; and
providing the hearing protection notification responsive to determining that a noise level in the audio sample exceeds a threshold noise level.

14. The method of claim 13, wherein obtaining the audio sample of the noise environment responsive to receiving the noise notification comprises, by the first electronic device:
receiving the noise notification and a plurality of additional noise notifications; and
waiting to obtain the audio sample of the noise environment until a threshold number of noise notifications have been received.

15. The method of claim 14, wherein the threshold noise level comprises a first threshold noise level that is lower than a second threshold noise level used by the second electronic device to trigger the noise notification.

16. The method of claim 1, wherein providing the hearing protection notification responsive to receiving the noise notification comprises:
determining, by the first electronic device, that a microphone of the first electronic device is in a container within the noise environment; and
providing the hearing protection notification responsive to receiving the noise notification and responsive to determining, by the first electronic device, that the first electronic device has been removed from the container.

17. A device comprising:
a memory; and
one or more processors configured to:
receive, directly and wirelessly from an other device, a noise notification;
determine, responsive to wirelessly receiving at least the noise notification, a noise level in a physical environment of the device; and
provide, responsive to determining that the noise level is above a threshold noise level, a hearing protection notification.

18. The device of claim 17, wherein the one or more processors are configured to determine the noise level, in part, by obtaining, with a microphone of the device, an audio sample of the physical environment.

19. The device of claim 17, wherein the one or more processors are configured to determine the noise level responsive to receiving the noise notification from the other device and at least one additional noise notification from at least one additional device.

20. The device of claim 17, wherein the device is associated with a first user account, and wherein the other device is associated with a second user account different from the first user account.

21. A method, comprising:
determining, by a first electronic device, that a noise level in a physical environment of the first electronic device is above a threshold noise level; and
providing, wirelessly by the first electronic device and responsive to the determining, a noise notification advertisement that is detectable within a predetermined range of the first electronic device.

22. The method of claim 21, wherein the predetermined range comprises a range of a wireless communication protocol, and wherein the noise notification advertisement comprises information indicating the noise level.

23. The method of claim 21, wherein the first electronic device is associated with a user account, wherein the noise notification advertisement is configured for detection by at least a second electronic device associated with a second user account, and wherein determining that the noise level in the physical environment of the first electronic device is above the threshold noise level comprises receiving a noise notification wirelessly from a third electronic device associated with the user account.
